(19) United States
(12) Patent Application Publication
(10) Pub. No.: US 2026/0183877 A1
(43) Pub. Date: Jul. 2, 2026

(54) Lift Device For Garbage Disposal Installation

(71) Applicant: Barbara Thomas, Goodyear, AZ (US)

(72) Inventor: Barbara Thomas, Goodyear, AZ (US)

(21) Appl. No.: 19/002,205

(22) Filed: Dec. 26, 2024

(51) Int. Cl. B23P 15/28

(52) U.S. Cl. CPC B23P 15/28

(57) ABSTRACT

A lift device for lifting and installing a garbage disposal includes a base column and a lead screw. The lead screw is threadably received into a channel of the base column and may be rotated to alternately raise and lower the lead screw with respect to the base column. An input disc is coupled to a top end of the lead screw, which may be rotated by a user to rotate the lead screw. An outer column is coupled to and surrounds the base column. A disposal support member is coupled to the outer column at the upper side of the outer column. The disposal support is shaped and configured to surround a lower portion of the garbage disposal and support an upper portion of the garbage disposal.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to lift devices and more particularly pertains to a new lift device for facilitating the positioning of a garbage disposal to install the garbage disposal below a sink or other support structure.

### (2) Description of Related Art Including Information Disclosed Under 37 CFR 1.97 and 1.98

Various lift devices are known to the prior art which are designed for use in lifting a garbage disposal during installation of the garbage disposal. However, the prior art fails to describe such an apparatus which comprises a lead screw that is rotatable via an input disc to alternately raise and lower the lift screw, which comprises an outer column which surrounds the lead screw, and a disposal support member which is mounted atop the outer column and supports the garbage disposal before lifting via the lead screw. Such an apparatus includes features for a user to turn the lead screw by hand in a confined space while encasing the lead screw and a base column to which the lead screw is threadably mounted. The prior art also fails to describe such an apparatus in which the garbage disposal may rest over the outer column via the disposal support member before a lifting procedure is performed to lift the garbage disposal via the lead screw.

### (h) BRIEF SUMMARY OF THE INVENTION

An embodiment of the disclosure meets the needs presented above by generally comprising a base column which defines a channel that extends into the base column through a top side of the base column. The base column is internally threaded. A lead screw is externally threaded and is threadably received in the channel of the base column. The lead screw is rotatable in a first rotational direction with respect to the base column to raise the lead screw with respect to the base column and is rotatable in a second rotational direction with respect to the base column to lower the lead screw with respect to the base column. An input disc is coupled to a top end of the lead screw, which may be rotated by a user to rotate the lead screw. An outer column is coupled to and surrounds the base column. A disposal support member is coupled to the outer column at the upper side of the outer column. The disposal support is shaped and configured to surround a lower portion of a garbage disposal and support an upper portion of the garbage disposal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a lift device according to an embodiment of the disclosure.

FIG. 2a is an exploded perspective view of a first set of components of an embodiment of the disclosure.

FIG. 2b is an exploded perspective view of a second set of components of an embodiment of the disclosure which assemble with the first set of components from FIG. 2a.

FIG. 3 is a top view of an embodiment of the disclosure.

FIG. 4 is a front view of an embodiment of the disclosure.

FIG. 5 is a rear view of an embodiment of the disclosure.

FIG. 6 is a cross-sectional view of an embodiment of the disclosure taken from Line 6-6 in FIG. 3.

FIG. 7 is an in-use view of an embodiment of the disclosure depicting a garbage disposal being loaded onto a disposal support member of the embodiment.

FIG. 8 is an in-use view of an embodiment of the disclosure depicting the garbage disposal from FIG. 7 being lifted by the embodiment for installation under a sink.

### (j) DETAILED DESCRIPTION OF THE INVENTION

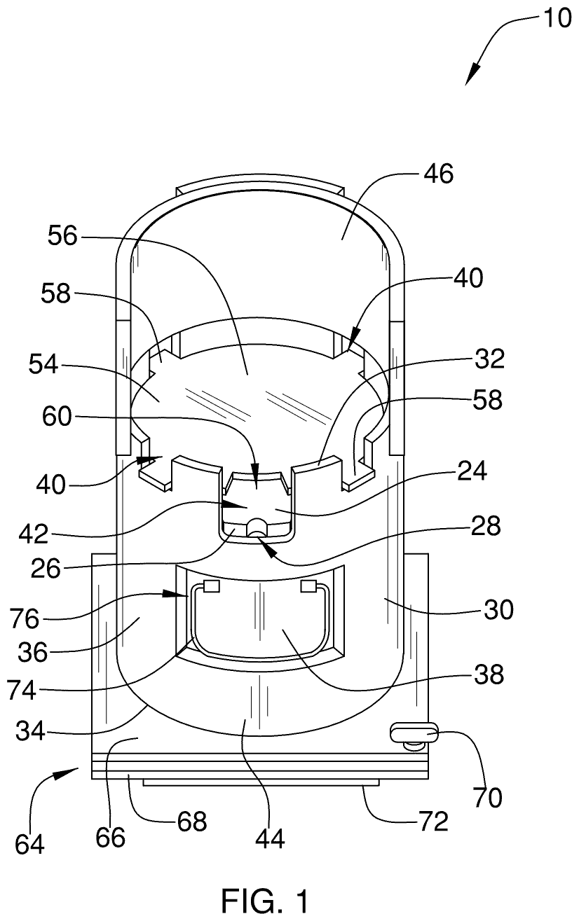

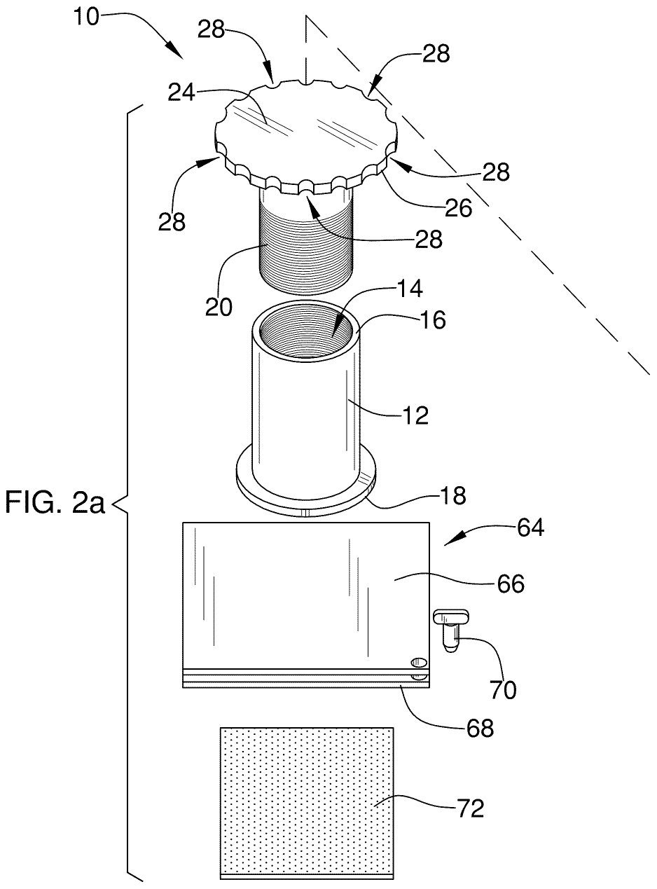

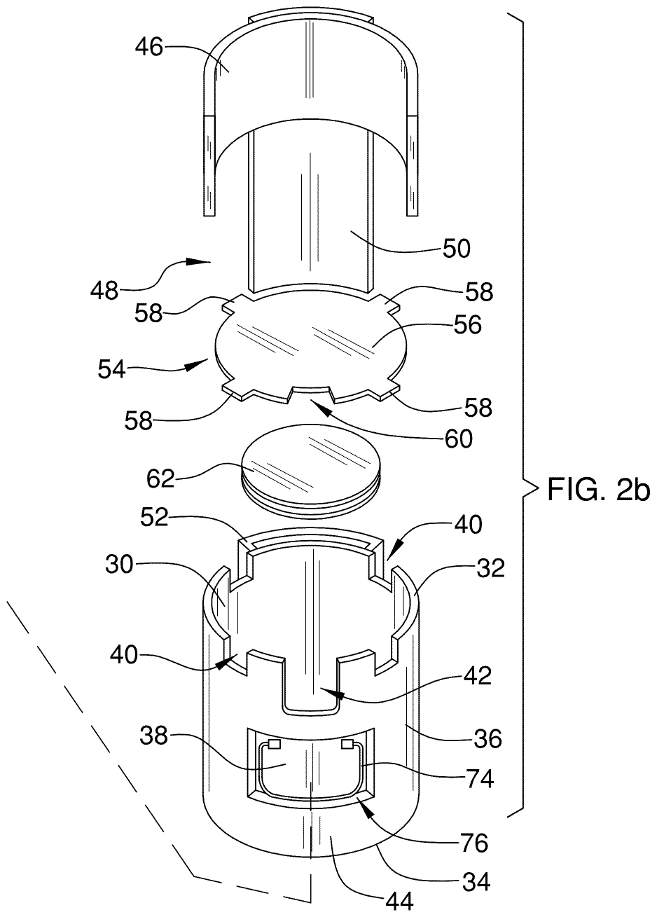

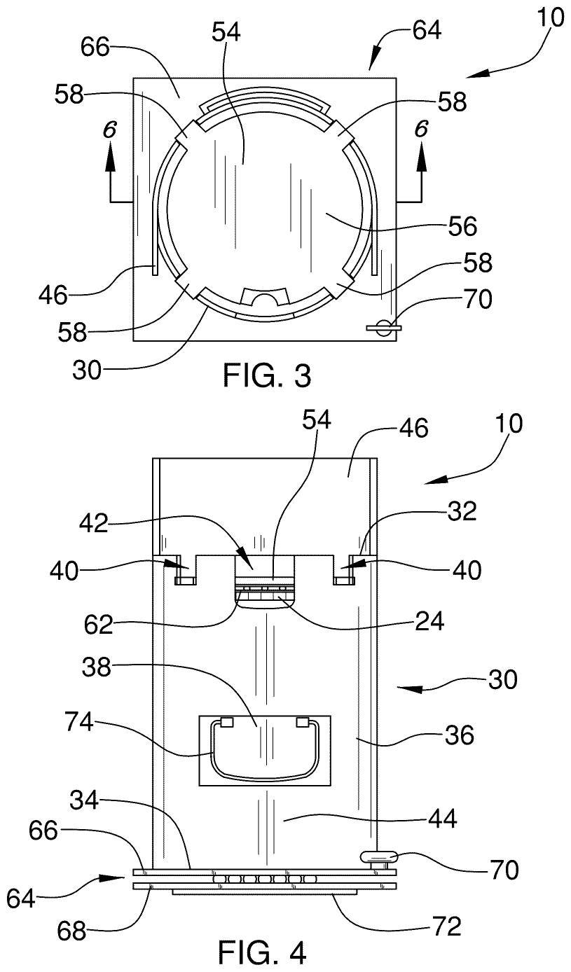

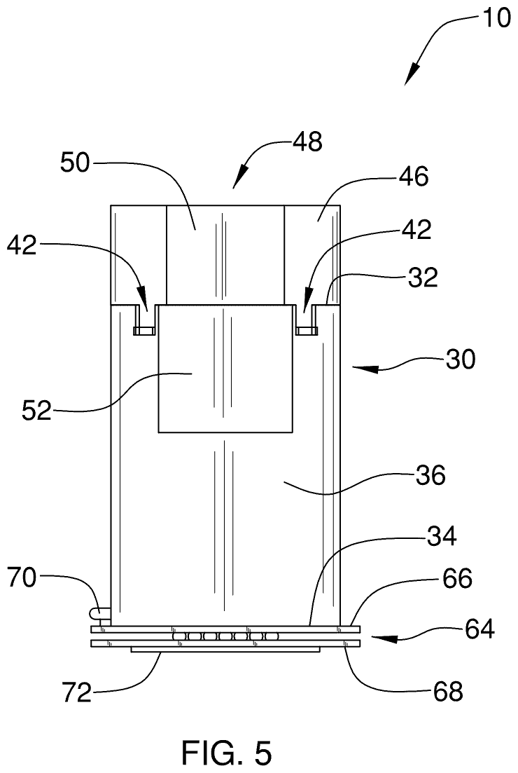

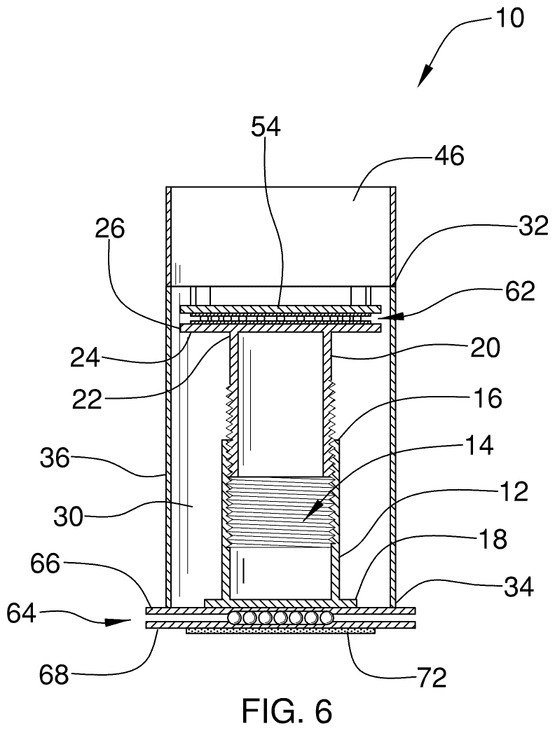

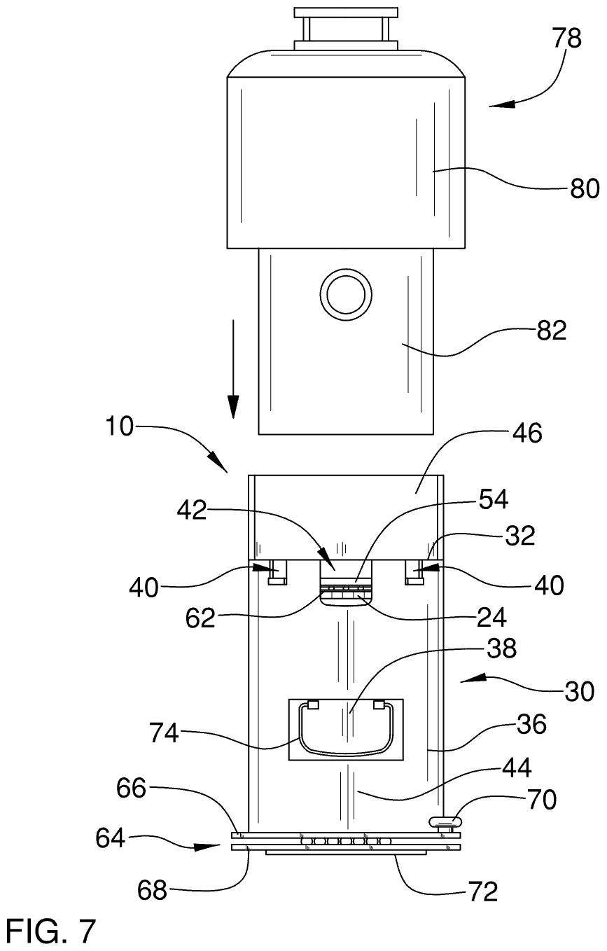

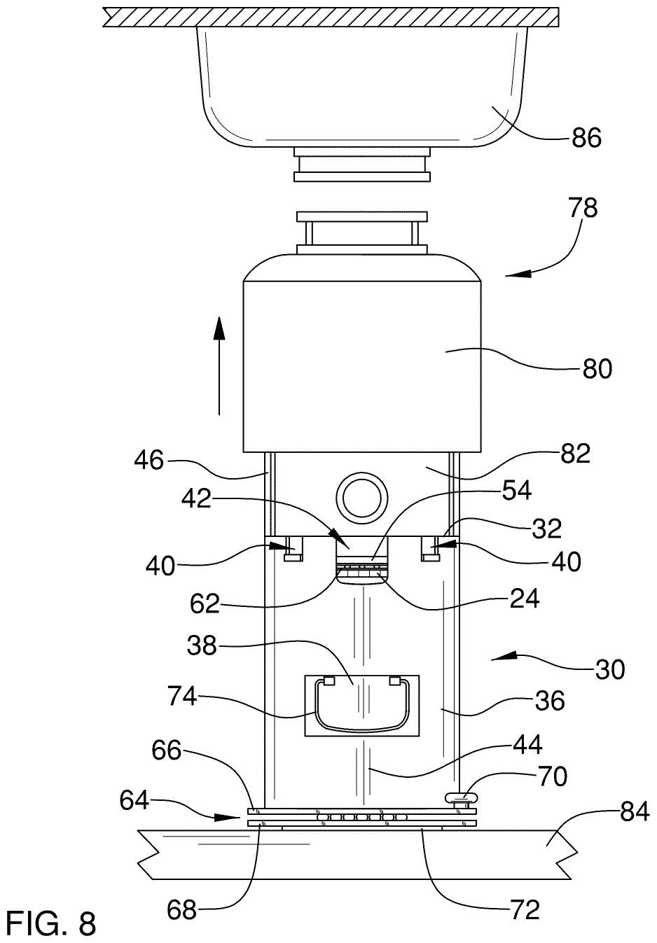

With reference now to the drawings, and in particular to FIGS. 1 through 8 thereof, a new lift device embodying the principles and concepts of an embodiment of the disclosure and generally designated by the reference numeral 10 will be described.

As best illustrated in FIGS. 1 through 8, the lift device 10 generally comprises a base column 12 which defines a channel 14 that extends into the base column 12 through a top side 16 of the base column 12. The base column 12 is internally threaded. A lead screw 20 is externally threaded and is threadably received in the channel 14 of the base column 12. The lead screw 20 is rotatable in a first rotational direction with respect to the base column 12 to raise the lead screw 20 with respect to the base column 12 and is rotatable in a second rotational direction opposite the first rotational direction with respect to the base column 12 to lower the lead screw 20 with respect to the base column 12. An input disc 24 is coupled to a top end 22 of the lead screw 20. The input disc 24 extends outwardly with respect to a rotational axis of the lead screw 20, and the input disc 24 defines a plurality of notches 28 around a perimeter 26 of the input disc 24. The input disc 24 may be rotated by a user to rotate the lead screw 20 with respect to the base column 12 to alternately raise and lower the lead screw 20. The notches 28 in the perimeter 26 of the input disc 24 are sized to facilitate enhancing a grip of the user on the input disc 24. The input disc 24 also may be frictionally enhanced by other rough textures, materials such as rubber or silicone, and other suitable means.

An outer column 30 is coupled to and surrounds the base column 12. The outer column 30 extends upwardly beyond the top side 16 of the base column 12. The outer column 30 defines a plurality of guide slots 40, each of which extends vertically with respect to the outer column 30 and is open at an upper side 32 of the outer column 30. The outer column 30 also defines an access aperture 42 in a front side 44 of the outer column 30 which extends into the outer column 30 to the input disc 24. The access aperture 42 facilitates the user to reach through the access aperture 42 to the input disc 24.

A disposal support member 46 is coupled to the outer column 30 at the upper side 32 of the outer column 30. The disposal support member 46 has a U-shape which is designed to surround a lower portion 82 of a garbage disposal 78 and support an upper portion 80 of the garbage disposal 78. Other suitable shapes may be used in other embodiments, such as a C-shape, a closed-loop ring-shape, or the like. A support connector 48 removably secures the disposal support member 46 to the outer column 30. The support connector 48 comprises an insertion member 50 and a receiver 52. The insertion member 50 is coupled to the disposal support member 46, and the receiver 52 is coupled to the outer column 30. The insertion member 50 is insertable into the receiver 52 to rest the disposal support member 46 atop the outer column 30 and prevent horizontal movement of the disposal support member 46 with respect to the outer column 30.

A platform 54 is slidably coupled to the outer column 30 and rests over the input disc 24. The platform 54 is slidable within the outer column 30 via the plurality of guide slots 40. The platform 54 comprises a hub panel 56 and a plurality of tabs 58. The tabs 58 are coupled to and radially spaced around the hub panel 56, and each tab 58 is positioned in an associated guide slot 40 of the plurality of guide slots 40 of the outer column 30. The platform 54 is also radially fixed with respect to the outer column 30 via the guide slots 40. A platform turntable 62 is coupled to and positioned between the platform 54 and the input disc 24. The platform turntable 62 facilitates rotation of the input disc 24 with respect to the platform 54. In other embodiments, the platform 54 may rest directly on the input disc 24 or otherwise be rotatably mounted atop the input disc 24. Guide rails or the like may be used in place of or in addition to the guide slots 40 in other embodiments to radially fix the platform 54 to the outer column 30. The platform 54 also defines a recess 60 adjacent to the input disc 24 and the access aperture 42 of the outer column 30 such that the user may avoid contact with the platform 54 when rotating the input disc 24.

A base turntable 64 is coupled to a bottom side 18 of the base column 12 and a lower side 34 of the outer column 30. The base turntable 64 comprises an upper member 66, a lower member 68, and a lock pin 70. The upper member 66 is rotatably mounted over the lower member 68, and the lock pin 70 is positionable to extend through the upper member 66 and the lower member 68 to fix the upper member 66 with respect to the lower member 68. In some embodiments, multiple holes may be formed in either the upper member 66 or the lower member 68 to allow the lock pin 70 to secure the upper member 66 in any of a plurality of positions with respect to the lower member 68.

A sliding pad 72 is coupled to the base turntable 64 opposite the base column 12. The sliding pad 72 comprises friction reducing material such that the sliding pad 72 is configured to be freely movable across a support surface 84 such as a floor of a cupboard or another surface under a point of installation for the garbage disposal 78. The friction reducing material may be polytetrafluoroethylene (PTFE, often sold under the trademark Teflon), metal, ceramic, or another suitable material for facilitating sliding the lift device 10 across the support surface 84. A handle 74 is coupled to the front side 44 of the outer column 30 and may be grasped by the user to slide or otherwise move the lift device 10. The handle 74 is pivotable with respect to the outer column 30 and may be positioned in a resting position 76 in which the handle 74 hangs from an inset surface 38 of the outer column 30. While in the resting position 76, the handle 74 is offset inwardly of an exterior surface 36 of the outer column 30 which prevents the handle 74 from catching on nearby items.

In use, the lift device 10 is slid into place underneath the point of installation for the garbage disposal 78. The garbage disposal 78 is placed atop the disposal support member 46, which may be before or after sliding the lift device 10 into place. The upper member 66 of the base turntable 64 may be rotated to adjust positioning of the garbage disposal 78 with respect to a sink 86 and a drain pipe or other mounting structures for the garbage disposal 78. The user reaches through the access aperture 42 of the outer column 30 and rotates the input device to raise the lead screw 20 and the platform 54. The platform 54 is lifted in this manner to push the garbage disposal 78 off of the disposal support member 46 and toward the point of installation. After using to lift the garbage disposal 78, the input disc 24 may be rotated again to lower the lead screw 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lift device for use with a garbage disposal, the lift device comprising:
a base column defining a channel which extends into the base column through a top side of the base column, the base column being internally threaded;
a lead screw coupled to the base column, the lead screw being externally threaded, the lead screw being threadably received in the channel of the base column, wherein a rotation of the lead screw in a first rotational direction with respect to the base column raises the lead screw with respect to the base column and a rotation of the lead screw in a second rotational direction with respect to the base column lowers the lead screw with respect to the base column;
an input disc coupled to a top end of the lead screw;
an outer column coupled to and surrounding the base column; and
a disposal support member coupled to the outer column at the upper side of the outer column, the disposal support being shaped and configured to surround a lower portion of the garbage disposal and support an upper portion of the garbage disposal.

2. The lift device of claim 1, wherein the input disc extends outwardly with respect to a rotational axis of the lead screw.

3. The lift device of claim 1, wherein the input disc defines a plurality of notches around a perimeter of the input disc.

4. The lift device of claim 1, wherein the outer column defines an access aperture in a front side of the outer column, the access aperture extending into the outer column to the input disc.

5. The lift device of claim 1, wherein the disposal support member has a U-shape.

6. The lift device of claim 1, further comprising a support connector removably securing the disposal support member to the outer column.

7. The lift device of claim 6, wherein the support connector comprises an insertion member and a receiver, the insertion member being insertable into the receiver, the insertion member being coupled to the disposal support member, the receiver being coupled to the outer column.

8. The lift device of claim 1, further comprising a platform slidably coupled to the outer column and resting over the input disc, the platform being radially fixed with respect to the outer column.

9. The lift device of claim 8, wherein:
the outer column defines a plurality of guide slots, each guide slot of the plurality of guide slots extending vertically with respect to the outer column; and
the platform comprises a hub panel and a plurality of tabs, the plurality of tabs being coupled to and radially spaced around the hub panel, each tab of the plurality of tabs being positioned in an associated guide slot of the plurality of guide slots of the outer column, the platform being radially fixed with respect to the outer column via the guide slots.

10. The lift device of claim 8, wherein the platform defines a recess adjacent to the input disc and the access aperture of the outer column.

11. The lift device of claim 8, further comprising a platform turntable coupled to and positioned between the platform and the input disc, the platform turntable facilitating rotation of the input disc with respect to the platform.

12. The lift device of claim 1, further comprising a base turntable coupled to a bottom side of the base column and a lower side of the outer column.

13. The lift device of claim 12, wherein the base turntable comprises an upper member, a lower member, and a lock pin, the upper member being rotatably mounted over the lower member, the lock pin being positionable to extend through the upper member and the lower member to fix the upper member with respect to the lower member.

14. The lift device of claim 1, further comprising a sliding pad coupled to and spaced below the base column, the sliding pad comprising friction reducing material such that the sliding pad is configured to be freely movable across a support surface.

15. The lift device of claim 1, further comprising a handle coupled to the front side of the outer column.

16. A lift device for use with a garbage disposal, the lift device comprising:
a base column defining a channel which extends into the base column through a top side of the base column, the base column being internally threaded;
a lead screw coupled to the base column, the lead screw being externally threaded, the lead screw being threadably received in the channel of the base column, wherein a rotation of the lead screw in a first rotational direction with respect to the base column raises the lead screw with respect to the base column and a rotation of the lead screw in a second rotational direction with respect to the base column lowers the lead screw with respect to the base column;
an input disc coupled to a top end of the lead screw, the input disc extending outwardly with respect to a rotational axis of the lead screw, the input disc defining a plurality of notches around a perimeter of the input disc;
an outer column coupled to and surrounding the base column, the outer column extending upwardly beyond the top side of the base column, the outer column defining a plurality of guide slots, each guide slot of the plurality of guide slots extending vertically with respect to the outer column, the plurality of guide slots being open at an upper side of the outer column, the outer column defining an access aperture in a front side of the outer column, the access aperture extending into the outer column to the input disc;
a disposal support member coupled to the outer column at the upper side of the outer column, the disposal support member having a U-shape wherein the disposal support member is configured to surround a lower portion of the garbage disposal and support an upper portion of the garbage disposal;
a support connector removably securing the disposal support member to the outer column, the support connector comprising an insertion member and a receiver, the insertion member being insertable into the receiver, the insertion member being coupled to the disposal support member, the receiver being coupled to the outer column;
a platform slidably coupled to the outer column and resting over the input disc, the platform comprising a hub panel and a plurality of tabs, the plurality of tabs being coupled to and radially spaced around the hub panel, each tab of the plurality of tabs being positioned in an associated guide slot of the plurality of guide slots of the outer column, the platform being radially fixed with respect to the outer column via the guide slots, the platform defining a recess adjacent to the input disc and the access aperture of the outer column;
a platform turntable coupled to and positioned between the platform and the input disc, the platform turntable facilitating rotation of the input disc with respect to the platform;
a base turntable coupled to a bottom side of the base column and a lower side of the outer column, the base turntable comprising an upper member, a lower member, and a lock pin, the upper member being rotatably mounted over the lower member, the lock pin being positionable to extend through the upper member and the lower member to fix the upper member with respect to the lower member;
a sliding pad coupled to the base turntable opposite the base column, the sliding pad comprising friction reducing material such that the sliding pad is configured to be freely movable across a support surface; and
a handle coupled to the front side of the outer column.
